(19) United States
(12) Patent Application Publication
(10) Pub. No.: US 2003/0165033 A1
(43) Pub. Date: Sep. 4, 2003

(54) Head support device and recording regenerator having this head support device

(75) Inventor: Yasutaka Sasaki, Tokyo (JP)

Correspondence Address: FOLEY & LARDNER, 2029 CENTURY PARK EAST, SUITE 3500, LOS ANGELES, CA, 90067

(73) Assignee: Kabushiki Kaisha Toshiba

(21) Appl. No.: 10/354,553

(22) Filed: Jan. 29, 2003

(30) Foreign Application Priority Data
Jan. 31, 2002 (JP) 2002-024758

(51) Int. Cl. G11B 5/55

(52) U.S. Cl. 360/265.9

(57) ABSTRACT

A head support device for improving the positioning accuracy of a head and for performing high density recording regeneration, and a recording regenerator having this head support device. A carriage has plural arms extending from a support portion, and a suspension with a head mounted thereto is extended from each arm. These arms are stacked up and arranged by the support portion along a predetermined direction. These arms include at least two inner arms back to back and adjacent to each other, and two outer arms respectively opposed to the inner arms at predetermined distances and located at both ends of the stacking direction. The support portion has first contact portions for contacting the outer arms and a second contact portion for contacting the inner arms. The first contact portions have a boundary shifted from the second contact portions in the extending direction of the arms.

### RELATED APPLICATIONS

This application is based upon and claims the benefit of priority from prior Japanese Patent Application No. 2002-24758, filed Jan. 31, 2002, the entire contents of which are incorporated herein by reference.

### BACKGROUND OF THE INVENTION

1. Field of the Invention

The present invention relates to a head support device mounting a head thereto, and a recording regenerator having this head support device.

2. Description of the Related Art

In recent years, recording regenerators such as a magnetic disk units and optical disk units have been widely used as an external recorder of a computer. For example, the magnetic disk unit using a magnetic recording medium generally has a magnetic disk arranged in a case, a spindle motor for supporting and rotating the magnetic disk, a carriage for movably supporting a magnetic head, a voice coil motor (VCM) for operating this carriage, a main flexible print circuit substrate (main FPC) for electrically connecting the magnetic head to a control section, etc.

In such a magnetic disk unit, the magnetic head is moved and positioned in an arbitrary radial position on the magnetic disk, i.e., on an arbitrary track by the carriage during rotation of the magnetic disk, and information is read and written to the magnetic disk by the magnetic head.

The carriage has a bearing assembly attached to the case, a plurality of arms extending from the bearing assembly, and a magnetic head assembly body fixed to an extending end of each of the plurality of arms. The magnetic head assembly body has an elongated suspension having a base end portion welded to a tip of the arm, and the magnetic head is mounted to an extending end of the suspension. Commonly, each of the plurality of arms is formed by a thin plate of stainless steel, etc. and the suspension is similarly formed by stainless steel, etc. in the shape of a thin leaf spring.

Two arms of the carriage and two magnetic head assembly bodies are arranged with respect to one magnetic disk, and are stacked and arranged so as to be opposed to both faces of the magnetic disk.

In the magnetic disk unit described above, because the arm of the carriage is formed by a thin plate, the arm is easily vibrated by impact in a vertical direction, i.e., a direction perpendicular to the magnetic disk surface. The arm is also easily vibrated when the actuator including the carriage is being driven. However, in reality, the actuator is twisted by the vertical swinging mode of the arm because of left-right asymmetrical actuator design. And also, the VCM generates an asymmetrical exciting-force which twists the actuator. As a result, these undesirable actuator vibration add a vibration component to tracking direction, especially around the arm bending mode frequency. Further, the head is also vibrated along an actuator longitudinal direction (tracking direction) by the vertical vibration of the arm, and this head vibration results in a jitter component. Therefore, it negatively influences positioning of the head and recording regeneration.

Furthermore, in the magnetic disk unit described above, as recording capacity is increased, high density data recording is required, and track density of the magnetic disk is equal to or smaller than 1 μm. Therefore, 0.1 μm or less in positioning accuracy of the magnetic head is needed. Accordingly, it is necessary to raise the servo bandwidth of the actuator controller. For example, in a 2.5 inch type magnetic disk unit, the present servo bandwidth ranges approximately from 500 Hz to 1 kilohertz (1 kHz), and further increases in the servo bandwidth are desirable.

One way to increase the servo bandwidth is to increase the rigidity of the carriage. However, many mechanical resonance modes of the carriage exist in the frequency band near 1 kHz or more, thus restricting increases in servo bandwidth beyond 1 kHz. For example, a bending vibration mode frequency of the arm is near about 1 kHz to 1.5 kHz, and the mode is excited by a vertical vibration and a twisting vibration generated when the carriage is driven.

In addition, because the vertical vibration mode frequency of the arm is in an area close to the servo bandwidth, there is a concern that the vibration mode may cause unstable conditions when the servo bandwidth is increased. Therefore, it is desirable to increase the arm stiffness and move a resonant frequency of the carriage further away from the servo bandwidth so as to achieve higher servo bandwidth control.

Examples of techniques to increase the arm stiffiness are disclosed in Jpn. Pat. Appln. KOKAI Publication No. 11-232805. However, because it is generally desirable that a recording regenerator, such as a magnetic disk unit, be thin, increases in arm thickness are undesirable. In addition, an increase in arm thickness increases the inertia of the arm. Thus, more power is required to operate the arm. However, in portable computers such as notebook computers it is important to keep the power requirements as low as possible.

Accordingly, it is desirable to increase a natural frequency of the arm bending vibration mode without increasing arm thickness.

### BRIEF SUMMARY OF THE INVENTION

Embodiments of the present invention provide a head support device which is able to perform high density recording regeneration by improving the head positioning accuracy, and a recording regenerator having this head support device.

Embodiments of the present invention provide a head support device having a support portion; plural arms each respectively formed by a thin plate and having a base end portion supported by the support portion and extending from the support portion in the same direction; a suspension extending from an extending end of each of at least two arms; and a head mounted to an extending end of each suspension.

The plural arms are stacked up and arranged along a predetermined direction, and include at least two inner arms back to back and adjacent to each other and two outer arms respectively opposed to the inner arms at predetermined distances and located at both ends of the stacking direction. The support portion has first contact portions for contacting the outer arms and second contact portions for contacting the inner arms, and the first contact portions have a boundary shifted toward the tip end of the arm in comparison with the second contact portions.

Further, according to further embodiments of the present invention, a head support device comprises a support portion; plural arms respectively formed by a thin plate and having a base end portion supported by the support portion and extending from the support portion in the same direction; a suspension extending from an extending end of each of at least two arms; and a head mounted to an extending end of each suspension. The plural arms are stacked up and arranged along a predetermined direction, and include at least two inner arms back to back and adjacent to each other and two outer arms respectively opposed to the inner arms at predetermined distances and located at both ends of the extending direction. The support portion has first contact portions for contacting the outer arms and second contact portions for contacting the inner arms, and the first and second contact portions have boundaries in different positions in the extending direction of the arms so as to set natural frequencies of the inner arms to be lower than those of the outer arms.

Further, according to embodiments of the present invention, a recording regenerator comprises a disk-shaped recording medium; a driving section for supporting and rotating the recording medium; a head for recording and regenerating information with respect to the recording medium; and the head support device for movably supporting the head with respect to the recording medium.

In accordance with the head support device constructed above and the recording regenerator having this head support device, it is possible to reduce an out-of-plane vibration amplitude of the outer arm which leads to cross talk to tracking direction by adjusting the large and small relation of out-of-plane bending stiffness between the inner and outer arms, and thereby the vibration cross talk in a tracking direction of the outer arm caused by this out-of-plane vibration can be reduced. Thus, the cross talks of the inner and outer arms in the tracking direction become almost equal such that the overall cross talk of all the heads can be reduced.

### BRIEF DESCRIPTION OF THE DRAWINGS

The accompanying drawings, which are incorporated in and constitute a part of the specification, illustrate embodiments of the invention, and together with the general description given above and the detailed description of the embodiments given below, serve to explain the principles of the invention.

FIG. 1 is a perspective view showing the interior of an HDD, according to embodiments of the present invention;

FIG. 2 is a perspective view of carriage parts arranged in the HDD, according to embodiments of the present invention;

FIG. 3 is a perspective view of the carriage, according to embodiments of the present invention;

FIG. 4 is a side view of the carriage, according to embodiments of the present invention;

FIG. 5 is a plan view showing the arrangement of a magnetic disk of the HDD in relation to the carriage, according to embodiments of the present invention;

FIG. 6 is a perspective view showing a spacer in a support portion of the carriage, according to embodiments of the present invention;

FIG. 7 is a graph showing vibration characteristics of the arm in the carriage of a conventional HDD;

FIG. 8 is a graph showing vibration characteristics of an arm in a carriage, according to embodiments of the present invention;

FIGS. 9a and 9b are views illustrating vibration modes of the arms, according to embodiments of the present invention;

FIG. 10 is a perspective view showing the bending mode of an arm of the carriage, according to embodiments of the present invention;

FIGS. 11a and 11b are side and end views respectively showing typical effects of vibration mode on the carriage, according to embodiments of the present invention;

FIG. 12 is a side view showing a carriage in the HDD, according to embodiments of the present invention;

FIG. 13 is a side view showing a carriage in the HDD, according to embodiments of the present invention;

FIG. 14 is a perspective view showing the carriage parts in the HDD, according to embodiments of the present invention;

FIG. 15 is a side view showing a carriage in the HDD, according to embodiments of the present invention; and

FIG. 16 is a perspective view showing the carriage parts in the HDD, according to embodiments of the present invention.

### DETAILED DESCRIPTION OF THE INVENTION

Embodiments of the present invention will now be described with reference to drawings illustrating the present invention as applied to a hard disk drive (HDD).

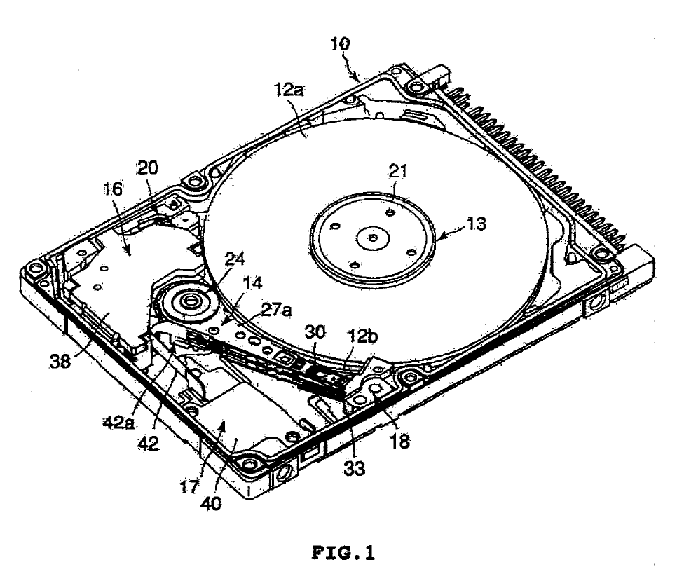

As shown in FIG. 1, the HDD has a case 10 formed in a rectangular box shape having an open upper face. A top cover (not shown) may be fastened to the case by a plurality of screws, thus enclosing the HDD.

The HDD comprises two magnetic disks 12a and 12b (which constitute a disk-shaped recording medium), a spindle motor 13 for supporting and rotating magnetic disks 12a and 12b, a plurality of heads for recording and regenerating information with respect to the magnetic disks 12a and 12b, a carriage 14 for movably supporting these magnetic heads with respect to the magnetic disks 12a and 12b, a voice coil motor (VCM) 16 for rotating and positioning the carriage, a ramp load mechanism 18, an inertial latch mechanism 20 for latching the carriage 14, and a substrate unit 17 having a circuit component such as a preamplifier mounted thereon are stored in the case 10. The ramp load mechanism 18 holds the magnetic head in a position separated from the magnetic disk when the head is moved to an outermost circumference of the magnetic disk.

The spindle motor 13, the VCM 16 and a print circuit substrate (not shown) for controlling an operation of the head are fastened by screws to an outer face of the case 10 through the substrate unit 17, and are located oppositely to a bottom wall of the case.

As an example, each of the magnetic disks 12a and 12b is formed to have a diameter of 65 mm (2.5 inches), and has a magnetic recording layer on each of upper and lower faces. The two magnetic disks 12a and 12b are mutually coaxially fitted to a hub of the spindle motor 13 (not shown), are clamped by a clamp spring 21, and are stacked up at a distance from 1 to 2 mm along an axial direction of the hub. The magnetic disks 12a and 12b are rotated at a predetermined speed by the spindle motor 13.

As shown in FIGS. 1 to 3, the carriage 14 constituting a head support device has a bearing assembly 24 fixed onto a bottom wall of the case 10. The bearing assembly 24 functioning as a support portion has a pivotal shaft 23 vertically arranged in the bottom wall of the case 10, and a cylindrical hub 26 rotatably supported by the pivotal shaft through a pair of bearings. A ring-shaped flange 29 is formed at an upper end of the hub 26, and a screw portion 25 is formed in the outer circumference of a lower end portion of the hub 26. The pivotal shaft 23 is arranged in parallel with a rotating shaft of the spindle motor 13.

The carriage 14 has four arms 27a, 27b, 27c and 27d cantilevered by the bearing assembly 24, two spacer rings 28a and 28b and four magnetic head assembly bodies 30 supported by the respective arms.

For example, each of the arms 27a, 27b, 27c and 27d is formed by stainless material such as SUS304 in the shape of a thin flat plate having a thickness of approximately 300 μm. A circular through hole 31 is formed at one end of the arm, i.e., in its base end portion.

Each magnetic head assembly body 30 has an elongated suspension 32 formed by a leaf spring and a magnetic head 33 fixed to the suspension. The suspension 32 includes a leaf spring having a plate thickness of 30 to 100 μm. A base end of this suspension 32 is fixed to tips of the arms 27a, 27b, 27c and 27d by, for example, spot welding or adhesion, and is extended from the arms.

Each magnetic head 33 has a slider having a substantially rectangular shape and a magnetic resistance (MR) head formed in this slider for recording regeneration. Each magnetic head 33 is fixed to a gimbal portion formed in a tip portion of the suspension 32. Each magnetic head 33 has four electrodes (not shown). The suspension 32 may also be formed integrally with the arm from the same material as that used in the arm.

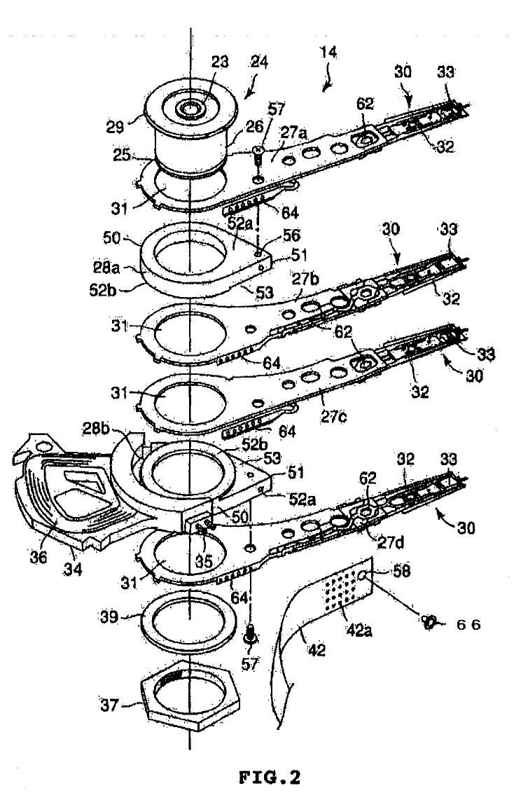

As shown in FIG. 2, each magnetic head 33 of the carriage 14 is electrically connected to a main FPC 42 (described later) through a trace flexible printed circuit (FPC) 62. The FPC 62 is stuck and fixed to surfaces of each arm of the carriage 14 and the suspension 32, and is extended from the tip of the suspension over a rotating base end of the arm. The FPC 62 is formed in an elongated band shape as a whole, and its end is electrically connected to the magnetic head 33. A base end portion of the FPC 62 is extended from the base end of the arm to the outside, and constitutes a connecting end portion 64 having a plurality of connecting pads.

As shown in FIGS. 2 to 4, the four arms 27a, 27b, 27c and 27d having the magnetic head assembly body 30 and the FPC 62 are fitted to the outer circumference of the hub 26 and stacked on the flange 29 along an axial direction of the hub 26 by inserting the hub 26 into the through hole 31. The spacer ring 28a is fitted to the outer circumference of the hub 26 such that the spacer ring 28a is nipped between the arms 27a and 27b. The spacer ring 28b is fitted to the outer circumference of the hub 26 such that the spacer ring 28b is nipped between the arms 27c and 27d.

The four arms 27a, 27b, 27c and 27d (fitted to the outer circumference of the hub 26) and the two spacer rings 28a and 28b are nipped and clamped between a nut 37 screwed to the screw portion 25 of the hub 26 and the flange 29, and are fixedly held on the outer circumference of the hub 26. A ring washer 39 is nipped between the nut 37 as a fastening member and the arm 27d. The hub 26, flange 29 and nut 37 constitute a nipping support mechanism.

The arms 27a, 27b, 27c and 27d supported by the bearing assembly 24 are extended in the same direction from the hub 26. The arms 27a and 27b are spaced from each other at a predetermined distance, and are located in parallel with each other. The magnetic heads 33 of the magnetic head assembly bodies 30 attached to the arms 27a and 27b are opposed to each other. Similarly, the arms 27c and 27d are spaced from each other at a predetermined distance, and are located in parallel with each other. The magnetic heads 33 of the magnetic head assembly bodies 30 attached to the arms 27c and 27d are opposed to each other.

The arms 27b and 27c are located back to back and come in contact with each other and function as inner arms in embodiments of this invention. The arms 27a and 27d located at upper and lower ends along a stacking direction function as outer arms in embodiments of this invention. The four arms 27a, 27b, 27c and 27d and the magnetic head assembly bodies 30 can be rotated integrally with the hub 26.

As shown in FIGS. 2 to 6, the spacer 28a integrally has a ring-shaped main body 50 fitted to the outer circumference of the hub 26, and an extending portion 51 extended from an outer circumference of this main body in an extending direction of the arm. An upper face of the spacer 28a opposed to the arm 27a at the upper end functioning as the outer arm is flatly formed over the main body 50 and the extending portion 51. This entire upper face constitutes a first contact face 52a coming in contact with the arm 27a, and defines a first clamp area for clamping the arm 27a.

In contrast to this, a recessed portion 53 is formed in a portion of the extending portion 51 on a lower face of the spacer 28a opposed to the arm 27b functioning as the inner arm, and is lowered by one step from a lower face of the main body 50. Only the lower face of the main body 50 constitutes a second contact face 52b coming in contact with the arm 27a, and defines a second clamp area for clamping the arm 27b.

Similarly, the spacer 28b integrally has a ring-shaped main body 50 fitted to the outer circumference of the hub 26, and an extending portion 51 extended from an outer circumference of this main body in the extending direction of the arm. A lower face of the spacer 28b opposed to the arm 27d at the upper end functioning as the outer arm is flatly formed over the main body 50 and the extending portion 51. This entire lower face constitutes a first contact face 52a coming in contact with the arm 27d, and defines a first clamp area for clamping the arm 27d.

A recessed portion 53 is formed in a portion of the extending portion 51 on an upper face of the spacer 28b opposed to the arm 27c functioning as the inner arm, and is lowered by one step from an upper face of the main body 50. Only the upper face of the main body 50 constitutes a second contact face 52b coming in contact with the arm 27c, and defines a second clamp area for clamping the arm 27c.

Note that spacers 28a and 28b have similar structures and that spacer 28a is shown in FIG. 6 in an orientation opposite to that shown, for example, in FIG. 4. This orientation clearly shows the recessed portion 53 of spacer 28a.

Further, the spacer ring 28b has a support frame 34 extending in a direction opposed to the arms 27a, 27b, 27c and 27d, and is integrally shaped by, for example, synthetic resin, etc. A voice coil 36 constituting one portion of the VCM 16 is molded to the support frame 34.

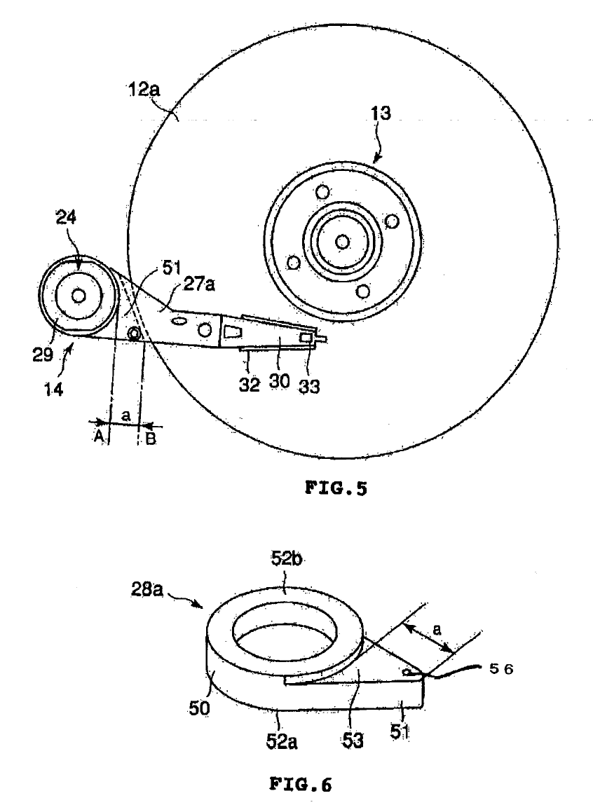

As shown in FIG. 5, the extending portions 51 arranged in the spacers 28a and 28b are desirably extended until limit positions in which the magnetic disks 12a and 12b and the spacers 28a and 28b do not contact each other when the carriage 14 is rotated such that the heads 33 are located in the innermost circumferences of the magnetic disks 12a and 12b. For example, an extending length “a” of the extending portion 51 may be set to 1 to 2 mm.

A screw hole 56 (see FIGS. 2 and 6) is formed in a tip portion of the extending portion 51 formed in the spacer 28a. A through hole is formed in the arm 27a in a position opposed to the screw hole 56. A screw 57 is screwed into the screw hole 56 of the extending portion 51 through this through hole. A base end portion of the arm 27a is closely attached to the extending portion 51 of the spacer 28a by fastening force of this screw 57, and is clamped on the first contact face 52a.

Similarly, a screw hole 56 is formed in a tip portion of the extending portion 51 formed in the spacer 28b. A through hole is formed in the arm 27d in a position opposed to the screw hole 56. A screw 57 is screwed into the screw hole 56 of the extending portion 51 through this through hole. A base end portion of the arm 27d is closely attached to the extending portion 51 of the spacer 28b by fastening force of this screw 57, and is clamped on the first contact face 52a.

In the above support structure, the first clamp area with respect to the arms 27a and 27d as the outer arms is extended on an arm extending end side by arranging the extending portion 51 in each of the spacers 28a and 28b. As shown in FIG. 5, the boundary of the arm extending end side of the first clamp area is moved from a peripheral edge position “A” of the spacer main body 50 to a position “B” on a tip side of the arm. Thus, an arm length of the arms 27a and 27d from the clamp area is equivalently shortened, and out-of-plane bending stiffness of these arms is increased. As a result, the natural bending frequencies of the arms 27a and 27d may be increased.

In contrast to this, the second clamp area of the spacers 28a and 28b is not extended on an extending end side of the arms 27b and 27c by arranging the recessed portion 53 in a portion of the extending portion 51 such that the boundary of the arm extending end side of the second clamp area is located at the peripheral edge position “A” of the spacer main body 50. In other words, the boundary of the arm extending end side of the second clamp area is shifted from the boundary of the first clamp area to a base end side of the arm. Therefore, the arms 27b and 27c functioning as the inner arms have a lower out-of-plane bending stiffness than do arms 27a and 27d, and their natural frequencies are low in comparison with the arms 27a and 27d functioning as the outer arms.

As shown in FIGS. 1 and 4, the magnetic disk 12a is located between the arms 27a and 27b and the magnetic disk 12b is located between the arms 27c and 27d when carriage 14 described above is assembled into the case 10.

When the HDD is operating, the magnetic heads 33 attached to the arms 27a and 27b are respectively opposed to upper and lower faces of the magnetic disk 12a, and nip and support the magnetic disk 12a on both faces. Similarly, the magnetic heads 33 attached to the arms 27c and 27d are respectively opposed to upper and lower faces of the magnetic disk 12b, and nip and support the magnetic disk 12b on both faces.

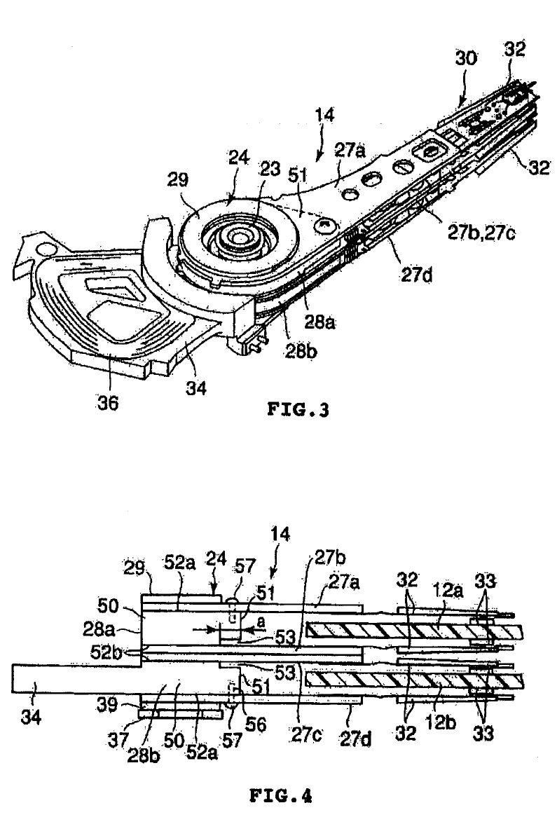

When the carriage 14 is assembled into the case 10, the voice coil 36 fixed to the support frame 34 (FIG. 3) is located between a pair of yokes 38 (FIG. 1) fixed onto the case 10. The voice coil 36 and support frame 34, together with these yokes 38 and a magnet (not shown) fixed to one of the yokes, constitute the VCM 16. The carriage 14 is rotated by flowing an electric current through the voice coil 36 so that the magnetic heads 33 are moved and positioned on desirable tracks of the magnetic disks 12a and 12b.

As shown in FIGS. 1 and 2, the unit 17 has a substrate main body 40 of a rectangular shape fixed onto the bottom wall of the case 10, and plural electronic parts, a connector, etc. are mounted onto this substrate main body. The unit 17 also has a main flexible print circuit substrate (main FPC) 42 of a band shape for electrically connecting the substrate main body 40 and the carriage 14. Each magnetic head 33 supported by the carriage 14 is electrically connected to the unit 17 through the FPC 62 and the main FPC 42.

More specifically, the main FPC 42 has a connecting end portion 42a attached to a bearing assembly 24 of the carriage 14 and a base end portion formed integrally with the substrate main body 40. A through hole 58 is formed in the connecting end portion 42a, and is fastened to the spacer ring 28a by a screw 66 inserted into this through hole. Each arm and the connecting end portion 64 of the FPC 62 arranged on the suspension 32 are respectively connected to a pad portion arranged in the connecting end portion 42a of the main FPC 42. Thus, each FPC 62 and the main FPC 42 are electrically connected to each other.

In accordance with the HDD described above, the boundary of the first clamp area for clamping the outer arms 27a and 27d is shifted and formed on an arm extending inside with respect to the boundary of the second clamp area for clamping the inner arms 27b and 27c so that the out-of-plane bending stiffness is different between the outer arms 27a and 27d and the inner arms 27b and 27c within the same carriage 14. Thus, when a vertical exciting force is applied to the voice coil 36, it is possible to obtain an effect such that the arms 27b and 27c having lower out-of-plane bending stiffness are greatly swung, while the swinging of the arms 27a and 27d, having higher out-of-plane bending stiffness, is reduced.

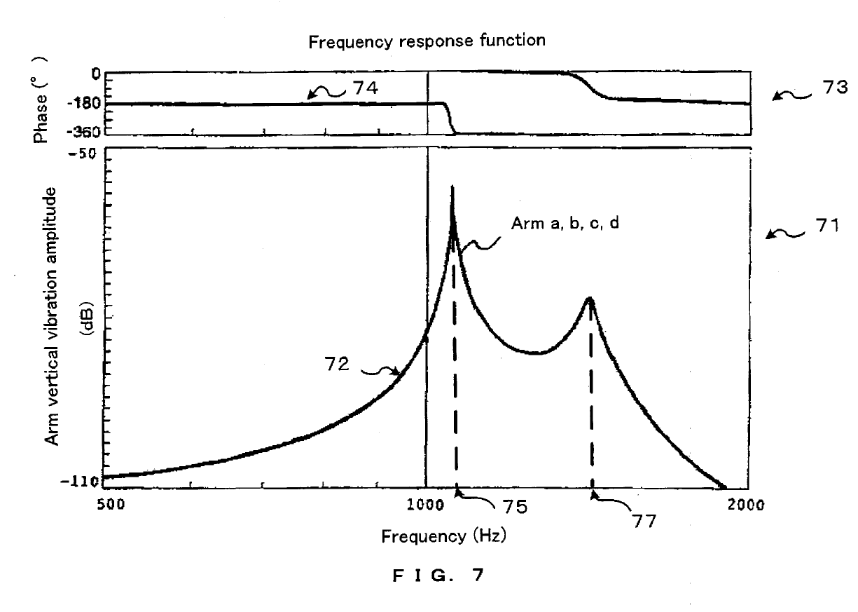

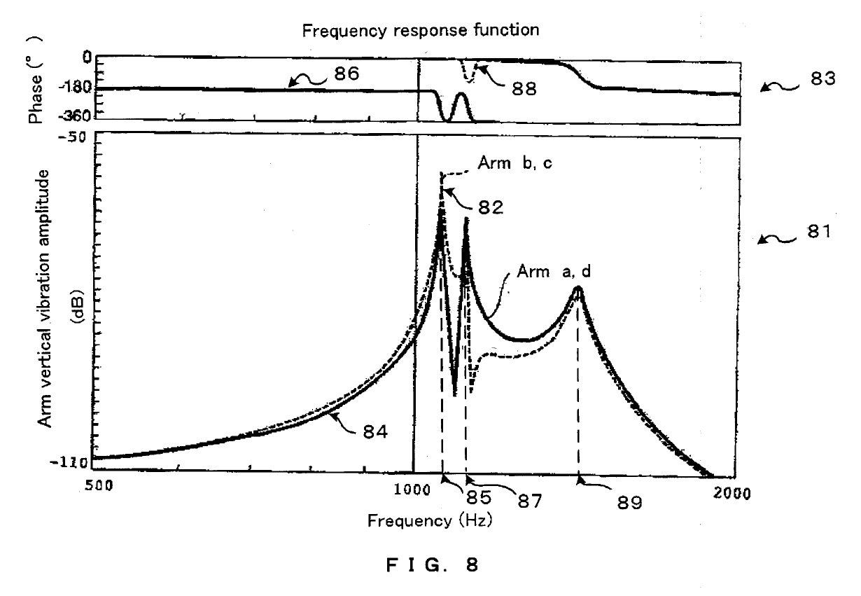

The reasons for this effect are illustrated by FIGS. 7 and 8. FIG. 7 includes a graph 71 showing a frequency response function for arms 27a, 27b, 27c, and 27d. The horizontal axis represents the frequency measured in hertz (Hz), while the vertical axis represents the vertical vibration amplitude of arms 27a, 27b, 27c, and 27d measured in decibels (dB). In the upper part of FIG. 7 is a corresponding graph 73 showing a plot 74 of the phase of the vertical vibration measured in degrees (vertical axis) for a frequency measured in Hz (horizontal axis).

In FIG. 7, a plot 72 represents the vertical vibration amplitude for arms 27a, 27b, 27c, and 27d in a conventional case in which the boundary of the first clamp area for clamping the outer arms 27a and 27d is the same as the boundary of the second clamp area for clamping the inner arms 27b and 27c such that the out-of-plane bending stiffness is also the same between the outer arms 27a and 27d and the inner arms 27b and 27c within the same carriage 14. In other words, FIG. 7 represents a case in which there are no recessed portions in the spacer rings, such as recessed portions 53 provided in spacer rings 28a and 28b according to embodiments of the present invention. Because the out-of-plane bending stiffness in arms 27b and 27c is the same as that in arms 27a and 27d, all of arms 27a, 27b, 27c, and 27d will have approximately the same resonant frequency.

As can be seen in FIG. 7, at the resonant frequency 75 for the arms 27a, 27b, 27c, and 27d, the vertical vibration amplitude of the arms is at a maximum. In addition, it can be seen that at the resonant frequency 75 there is a 180 degree shift in the phase of the vertical vibration of arms 27a, 27b, 27c, and 27d.

It can also be seen in FIG. 7 that the plot 72 peaks again at the resonant frequency 77 of the voice coil. However, the resonant frequency 77 of the voice coil may be disregarded for purposes of the embodiments of the present invention described herein.

Referring now to FIG. 8, another graph 81 showing a frequency response function for arms 27a, 27b, 27c, and 27d is shown. In the upper part of FIG. 8 is a corresponding graph 83 showing a plot 86 of the phase of the vertical vibration measured in degrees (vertical axis) versus the frequency measured in Hz (horizontal).

FIG. 8 represents a case in which the boundary of the first clamp area for clamping the outer arms 27a and 27d is shifted and formed on an arm extending end side with respect to the boundary of the second clamp area for clamping the inner arms 27b and 27c so that the out-of-plane bending stiffness is different between the outer arms 27a and 27d and the inner arms 27b and 27c within the same carriage 14. In other words, FIG. 8 represents a case in which there are recessed portions 53 in the spacer rings 28a and 28b, according to embodiments of the present invention.

Because of the shift in boundaries of the clamping areas for clamping the outer arms 27a and 27d and the inner arms 27b and 27c, respectively, the inner and outer arms will now have a different resonant frequency. Due to the fact that inner arms 27b and 27c have a lower out-of-plane bending stiffness than do the outer arms 27a and 27d, the inner arms 27b and 27c will have a lower resonant frequency than the outer arms 27a and 27d.

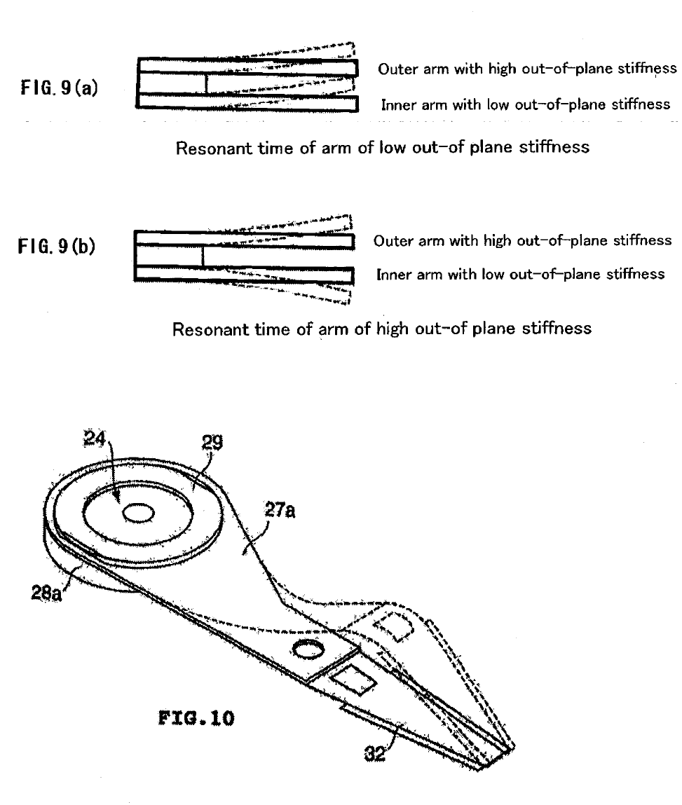

In FIG. 8, a plot 82 (shown as a broken line) represents the vertical vibration amplitude for inner arms 27b and 27c, while plot 84 (shown as a solid line) represents the vertical vibration amplitude for outer arms 27a and 27d. It can be seen in FIG. 8 that at the resonant frequency 85 of the inner arms 27b and 27c, the vertical vibration amplitude of the inner arms 27b and 27c is at a maximum and is greater than the vertical vibration amplitude of the outer arms 27a and 27d. It can also be seen that at the resonant frequency 85 of the inner arms 27b and 27c, there is a 180 degree phase shift of the vertical vibration and that the phase the same for arms 27a, 27b, 27c, and 27d. Thus, at the resonant frequency of the inner arms 27b and 27c, the inner and outer arms swing in the same direction, as shown in FIG. 9(a).

At the resonant frequency 87 of the outer arms 27a and 27d, the vertical vibration amplitude of the outer arms 27a and 27d is at a maximum. However, it can be seen that at the resonant frequency 87, the phase 89 of the vertical vibration of the inner arms 27b and 27c is reversed in relation to the phase of outer arms 27a and 27d. Thus, at the resonant frequency of the outer arms 27a and 27d, the inner and outer arms swing in opposite directions, as shown in FIG. 9(b). This phase reversal of the inner arms 27b and 27c in effect acts to cancel some of the energy of the vibrations. As a result, the vertical vibration amplitude of the outer arms 27a and 27d is reduced, as shown in FIG. 8.

As in FIG. 7, it can be seen in FIG. 8 that the plots 82 and 84 peak again at the resonant frequency 89 of the voice coil. However, the resonant frequency 89 of the voice coil may be disregarded for purposes of the embodiments of the present invention described herein.

Some of the advantages of the reduction in vertical vibration amplitude of the outer arms 27a and 27d due to the effects discussed above will now be described. As shown in FIG. 10, driving the VCM 16 produces a force which excites arm vibration in an out-of-plane bending direction. This force is applied to the voice coil 36 in a vertical direction or a twisting direction and causes cross talk vibration in the tracking direction of the magnetic head. This cross talk vibration comprises two components. A first component is cross talk which is generated by the direction of the out-of-plane vibration of the arm. A second component is generated by swinging the entire carriage 14 in the tracking direction as a result of the out-of-plane vibration of the arm.

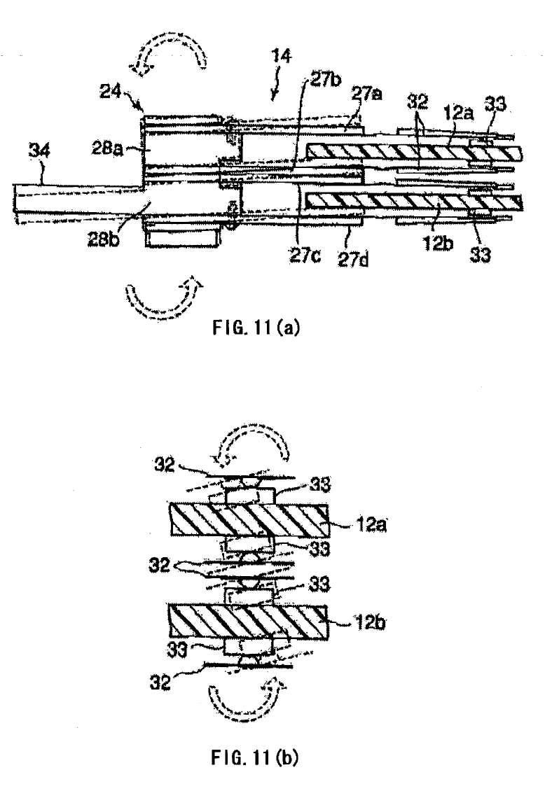

However, even if the inner arms 27b and 27c and the outer arms 27a and 27d have approximately the same vertical vibration amplitude, their different arrangement on the carriage 14 may result in different contributions of each to the total cross talk vibration produced. This is because the swinging of the entire carriage 14 is mainly generated by a spring property of the bearing assembly 24 and inertia of the entire carriage. Therefore, as shown in FIGS. 11(a) and 11(b), the inner arms 27b and 27c located near the center of the carriage 14 have small amplitudes as a result of the second component compared to the outer arms 27a and 27d located further from the center of the carriage 14. Accordingly, the amount of the cross talk generated by inner arms 27b and 27c due to the vibration of the entire carriage 14 is less than that generated by outer arms 27a and 27d.

In addition, because the inner arms 27b and 27c are arranged back to back, the friction of the contacting surfaces of the two inner arms 27b and 27c causes a damping effect. Thus, the out-of-plane vibration amplitude of the inner arms 27b and 27c may be smaller than that of the outer arms 27a and 27d.

Thus, it can be seen that the out-of-plane vibration amplitude of the inner arms 27b and 27c contributes less to the overall cross talk vibration than does that of the outer arms 27a and 27d. Therefore, embodiments of the present invention may be used to reduce the amount of cross talk vibration caused by outer arms 27a and 27d by shifting and forming the boundary of the first clamp area for clamping the outer arms 27a and 27d on an arm extending end side with respect to the boundary of the second clamp area for clamping the inner arms 27b and 27c. As a result, the out-of-plane bending stiffness of the outer arms 27a and 27d is different from the out-of-plane bending stiffness of the inner arms 27b and 27c within the same carriage 14.

As shown above, such shifting of the boundary of the first clamp area results in less out-of-plane bending stiffness for the inner arms 27b and 27c. As a result, the vertical vibration amplitude of the inner arms 27b and 27c due to a given exciting force will be increased. In addition, however, the resonant frequency of the inner arms 27b and 27c will be different from that of the outer arms 27a and 27d. When the resonant frequency of the outer arms 27a and 27d occurs, the phase of the vibration of the inner arms 27b and 27c will be opposite to that of the outer arms 27a and 27d. The opposite phases will cancel some of the energy of the vibrations, resulting in a reduction in the vertical vibration amplitude of the outer arms 27a and 27d, as shown in FIG. 8. The reduction in the vertical vibration amplitude of the outer arms 27a and 27d, in turn, results in a reduction in the contribution of the outer arms 27a and 27d to the overall cross talk vibration.

Thus, it can be seen that due to their reduced out-of-plane bending stiffness, the contribution of the inner arms 27b and 27c to the overall cross talk vibration has increased somewhat. However, at the same time, the contribution of the outer arms 27a and 27d to the overall cross talk vibration has decreased due to a cancellation of some of the energy of the vibrations. As a result, the contributions of the inner arms 27b and 27c and the outer arms 27a and 27d to the overall cross talk vibration are approximately the same, and the overall cross talk vibration is reduced.

Thus, the overall cross talk vibration resulting from the out-of-plane bending vibration of the inner and outer arms near a frequency of 1 kHz is reduced, and an increase in the servo bandwidth of a positioning servo system is advantageously made possible. Accordingly, increases in the track density of the magnetic disks are made possible by embodiments of the present invention, and high density recording can be obtained.

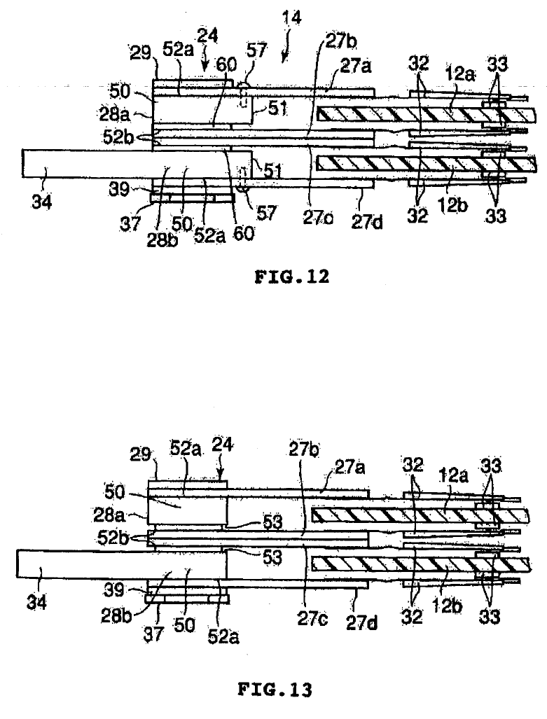

In the embodiment of the present invention described above, each of the spacers 28a and 28b is constructed such that the recessed portion 53 is formed in a portion of the extending portion 51 on a surface side opposed to the inner arm. However, as shown in FIG. 12, the entire surface of the spacer opposed to the inner arm may be flatly formed, and another flat spacer ring 60 may also be arranged between this surface and the inner arm 27b or 27c. In this case, the spacer ring 60 is formed so as to approximately have the same diameter as the main body 50 of the spacers 28a and 28b. Thus, a contact face of the spacer ring 60 with respect to the inner arm 27b or 27c constitutes the second contact face 52b and the second clamp area so that operating effects similar to those in the above-described embodiment can be obtained.

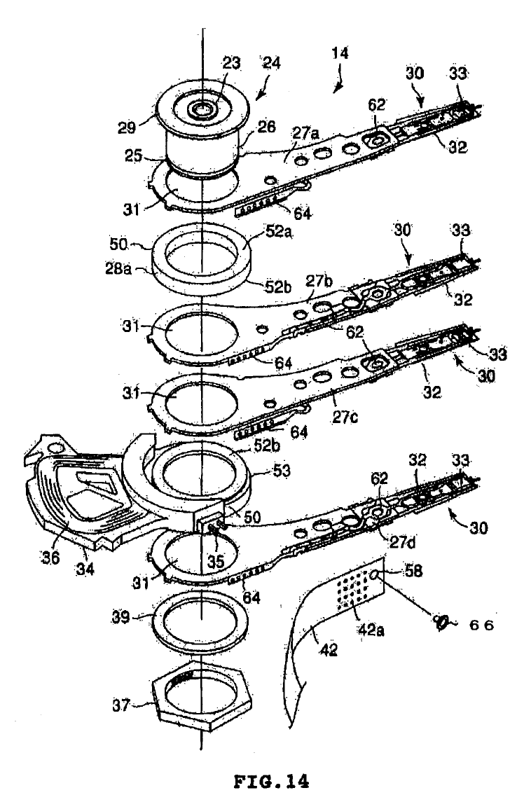

In accordance with a further embodiment of the present invention shown in FIGS. 13 and 14, neither of the spacers 28a and 28b has the above extending portion 51. Instead, the spacer 28a has only the ring-shaped main body 50, and the entire upper face of the main body 50 opposed to the arm 27a constitutes the first contact face 52a coming in contact with the arm 27a, and defines the first clamp area for clamping the arm 27a. As can be seen from FIG. 13, the screws 57 are not utilized in this embodiment because of the absence of the extending portions. Therefore, one of the advantages of this embodiment is a reduction in the number of parts used.

Further, the ring-shaped recessed portion 53 is formed on the edge around the entire circumference of a lower face of the main body 50 opposed to the arm 27b. Thus, the lower face of the main body 50 comes in contact with the arm 27b, and constitutes the second contact face 52b of an outside diameter smaller than that of the main body 50, and this second contact face defines the second clamp area for clamping the arm 27b.

In contrast, the spacer 28b has the ring-shaped main body 50 and the support frame 34. The entire lower face of the main body 50 opposed to the arm 27d constitutes the first contact face 52a coming in contact with the arm 27d, and defines the first clamp area for clamping the arm 27d. The ring-shaped recessed portion 53 is formed on the edge around the entire circumference of an upper face of the main body 50 opposed to the arm 27c. Thus, the upper face of the main body 50 comes in contact with the arm 27c, and constitutes the second contact face 52b of an outside diameter smaller than that of the main body 50, and this second contact face defines the second clamp area for clamping the arm 27c.

As mentioned above, the second clamp area of the spacers 28a and 28b is formed to have an outside diameter smaller than that of the first clamp area, and the boundary of an arm extending end side of the second clamp area is shifted and located on a base end side of the arm from the boundary of the first clamp area. Therefore, the arms 27b and 27c functioning as the inner arms have lower out-of-plane bending stiffness and a lower natural frequency than the arms 27a and 27d functioning as the outer arms. The recessed portion 53 formed in the main body 50 of the spacers 28a and 28b is not limited to the ring shape, but may also be formed only on the edge around a portion of the circumference of the main body on its arm extending end side.

The remaining features of this embodiment, and their operation, are the same as those of earlier embodiments of the present invention described above, and are designated by similar reference numerals. Therefore, a detailed explanation of those similar features and their operation is omitted here.

As in previously described embodiments, the overall cross talk vibration resulting from the out-of-plane bending vibration of the inner and outer arms near a frequency of 1 kHz is reduced, and an increase in the servo bandwidth of a positioning servo system is advantageously made possible. Accordingly, increases in the track density of the magnetic disks are made possible.

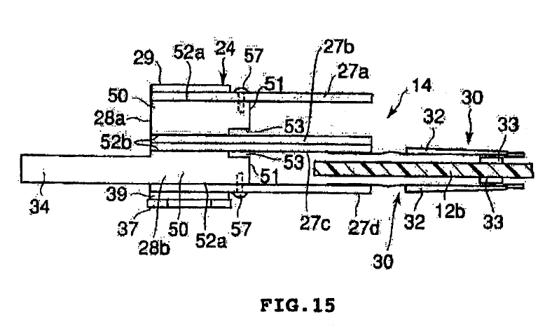

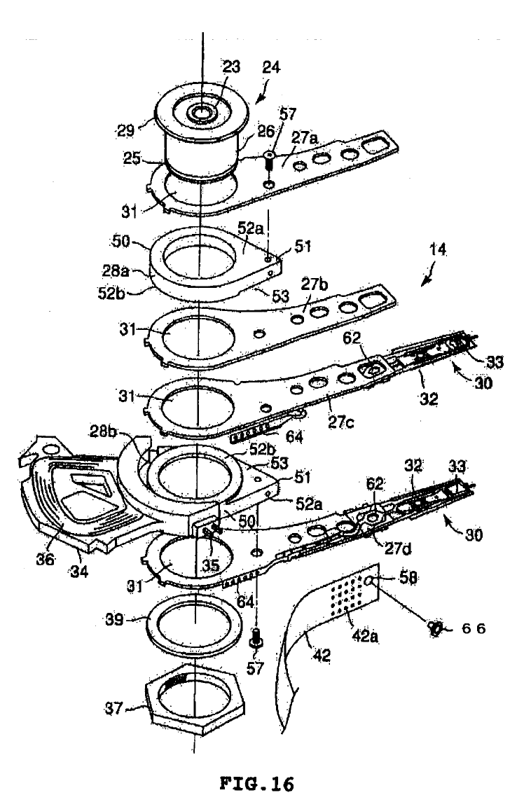

Yet a further embodiment of the present invention is shown in FIGS. 15 and 16. According to this embodiment, carriage 14 is employed in a HDD having only a single magnetic disk 12b. A magnetic head assembly body is attached to each of only one inner arm and one outer arm. As an example, as shown in FIGS. 15 and 16, carriage 14 has four arms, inner arms 27b and 27c and outer arms 27a and 27d. A magnetic head assembly body 30 is attached to each of inner arm 27c and outer arm 27d. However, in contrast to previously described embodiments of the present invention, inner arm 27b and outer arm 27a are dummy arms, i.e., there is no magnetic head assembly body attached to these arms because there is no magnetic disk located between them. In one embodiment having only a single magnetic disk 12b, inner arm 27b and outer arm 27a would each be formed to include only through hole 31 and the hole aligned with screw hole 56. No further openings would be included on inner arm 27b and outer arm 27a so as to increase their mass. This may be done to compensate for the lack of suspension 32 and magnetic head 33 on each of inner arm 27b and outer arm 27a.

The remaining features of this embodiment, and their operation, are the same as those of earlier embodiments of the present invention described above, and are designated by similar reference numerals. Therefore, a detailed explanation of those similar features and their operation is omitted here.

As in previously described embodiments, the overall cross talk vibration resulting from the out-of-plane bending vibration of the inner and outer arms near a frequency of 1 kHz is reduced, and an increase in the servo bandwidth of a positioning servo system is advantageously made possible. Accordingly, increases in the track density of the magnetic disk are made possible.

It is to be understood that even though numerous characteristics and advantages of various embodiments of the present invention have been set forth in the foregoing description, together with details of the structure and function of various embodiments of the invention, this disclosure is illustrative only. Changes may be made in detail, especially matters of structure and management of parts within the principles of the present invention to the full extent indicated by the broad general meaning of the terms in which the appended claims are expressed. For example, in the above embodiments, a recording regenerator having one or two recording media and the head support device employed with this recording regenerator are described. However, embodiments of the present invention may also be employed with a recording regenerator having three or more recording media and the head support device employed with this recording regenerator. In addition, this invention is not limited to a magnetic disk unit, but may also be employed with other recording regenerators, such as, but not limited to, an optical disk unit and a magneto-optic disk unit and their head support devices.

As described above in detail, in accordance with embodiments of the present invention, it is possible to provide a head support device of simple construction that reduces the overall cross talk vibration resulting from the out-of-plane bending vibration of the inner and outer arms near a natural frequency of the arms, and increases the servo bandwidth of a positioning servo system, and a recording regenerator using this head support device. Accordingly, it is possible to increase the track density of the recording media and perform higher density recording regeneration.

What is claimed is:

1. A head support device for supporting first and second heads for at least one of reading data from and writing data to a recording medium, comprising:
a first arm for supporting the first head;
a support member including a first contact portion for contacting the first arm and a second contact portion opposed to the first contact portion, the second contact portion having a recessed portion, and
a second arm contacted by the second contact portion for supporting the second head.

2. The head support device according to claim 1, wherein each of the first and second arms include a base end portion having a through hole formed therein; and
wherein said support member further includes:
a hub formed in an approximately cylindrical shape and inserted and fitted into the through hole of each of the first and second arms; and
a spacer fitted to an outer circumference of said hub and respectively nipped between the first arm and the second arm opposed to the first arm, and a nipping support mechanism for supporting said spacer and the base end portion of each of the first and second arms along a stacking direction;
wherein said spacer has a first contact face contacting the base end portion of the first arm and forming the first contact portion, and a second contact face contacting the base end portion of the second arm and forming the second contact portion.

3. The head support device according to claim 2, wherein said spacer includes:
a ring-shaped main body and an extending portion integrally formed with the ring-shaped main body, the extending portion extending from the main body,
a first surface extending over the main body and the extending portion and forming the first contact face; and
a second surface located on a side opposed to the first surface and extending over the main body and the extending portion and forming the second contact face, the second surface including a recessed portion formed thereon in the extending portion.

4. The head support device according to claim 2, wherein the support member further includes a flange formed at one end of the hub, and a fastening member fastened to the other end of the hub and supporting the base end portion of each of the first and second arms and said spacer between the fastening member and the flange.

5. The head support device according to claim 2, wherein a portion of the first arm is fastened to said spacer by a screw.

6. A head support device for supporting first and second heads for at least one of reading data from and writing data to a recording medium, comprising:
a first arm for supporting the first head, the first arm having an extending portion near the first head;
a support member having a first contact portion for contacting the first arm and a second contact portion opposed to the first contact portion, the second contact portion having a recessed portion, the first contact portion being shifted from the second contact portion in a direction toward the extending portion; and
a second arm contacted by the second contact portion for supporting the second head.

7. A head support device for supporting first and second heads for at least one of reading data from and writing data to a recording medium, comprising:
a first arm for supporting the first head, the first arm having a first extending portion near the first head;
a second arm for supporting the second head, the second arm having a second extending portion near the second head; and
a support member having a first contact portion for contacting the first arm and a second contact portion opposed to the first contact portion for contacting the second arm, the second contact portion having a recessed portion, said first and second contact portions having different contact boundaries in the first and second extending directions of said first and second arms such that a natural bending frequency of the second arm is lower than a natural bending frequency of the first arm.

8. A head support device for supporting first and second heads for at least one of reading data from and writing data to a recording medium, comprising:
a first arm for supporting the first head, the first arm having an extending portion near the first head;
a second arm opposed to the first arm for supporting the second head, the second arm having a second extending portion near the second head;
a plurality of spacers nipped between the first arm and the second arm; and
a support mechanism for supporting a base end portion of the first and second arms and the plurality of spacers along a stacking direction;
wherein the plurality of spacers include a first spacer having a first contact face contacting the base end portion of the first arm and forming a first contact portion, and a second spacer having a second contact face contacting the base end portion of the second arm and forming a second contact portion opposed to the first contact portion; and
wherein the first contact portion is shifted from the second contact portion in a direction toward the first and second extending portions.

9. The head support device according to claim 8, wherein a natural bending frequency of the second arm is lower than a natural bending frequency of the first arm.

10. The head support device according to claim 8, wherein a portion of the first arm is fastened to the first spacer by a screw.

11. A head support device for supporting first and second heads for at least one of reading data from and writing data to a recording medium, comprising:
a first arm for supporting the first head, the first arm having a first extending portion near the first head;
a second arm for supporting the second head, the second arm having a second extending portion near the second head; and
a plurality of spacers stacked between the first and second arms, the plurality of spacers including:
a first spacer having a ring-shaped main body and an integrally formed extending portion extending from the main body, and further having a first surface extending over the main body and the extending portion and forming a first contact face, the first contact face having a first contact portion for contacting the first arm; and
a second spacer having a ring-shaped main body and a second surface forming a second contact face, the second contact face having a second contact portion opposed to the first contact portion for contacting the second arm, the main body of the second spacer having a diameter approximately equal to a diameter of the main body of the first spacer such that the first contact portion is shifted from the second contact portion in a direction toward the first and second extending portions.

12. The head support device according to claim 11, wherein a natural bending frequency of the second arm is lower than a natural bending frequency of the first arm.

13. The head support device according to claim 11, wherein a portion of the first arm is fastened to the extending portion of the first spacer by a screw.

14. A head support device for supporting first and second heads for at least one of reading data from and writing data to a recording medium, comprising:
a first arm for supporting the first head, the first arm having a first extending portion near the first head;
a second arm for supporting the second head, the second arm having a second extending portion near the second head; and
at least one spacer stacked between the first and second arms, the at least one spacer including a ring-shaped main body having a first surface forming a first contact face having a first contact portion for contacting the first arm and a second surface located on a side opposed to the first surface and forming a second contact face having a second contact portion for contacting the second arm, the second contact face including a recessed portion formed in at least a peripheral edge portion of the second surface such that the first contact portion is shifted from the second contact portion in a direction toward the first and second extending portions.

15. A disk apparatus comprising:
a driving mechanism for supporting and rotating a disk-shaped medium;
at least first and second heads for at least one of reading data from and writing data to the medium; and
a head support device for supporting the first and second heads, the head support device comprising:
a first arm for supporting the first head;
a support member including a first contact portion for contacting the first arm and a second contact portion opposed to the first contact portion, the second contact portion having a recessed portion, and
a second arm contacted by the second contact portion for supporting the second head;
wherein the at least first and second heads are movably supported with respect to the medium.

16. The disk apparatus according to claim 15, wherein each of the first and second arms include a base end portion having a through hole formed therein; and
wherein said support member further includes:
a hub formed in an approximately cylindrical shape and inserted and fitted into the through hole of each of the first and second arms; and
a spacer fitted to an outer circumference of said hub and respectively nipped between the first arm and the second arm opposed to the first arm, and a support mechanism for supporting said spacer and the base end portion of each of the first and second arms along a stacking direction;
wherein said spacer has a first contact face contacting the base end portion of the first arm and forming the first contact portion, and a second contact face contacting the base end portion of the second arm and forming the second contact portion.

17. The disk apparatus according to claim 16, wherein said spacer includes:
a ring-shaped main body and an extending portion integrally formed with the ring-shaped main body, the extending portion extending from the main body,
a first surface extending over the main body and the extending portion and forming the first contact face; and
a second surface located on a side opposed to the first surface and extending over the main body and the extending portion and forming the second contact face, the second surface including a recessed portion formed thereon in the extending portion.

18. The disk apparatus according to claim 16, wherein the support member further includes a flange formed at one end of the hub, and a fastening member fastened to the other end of the hub and nipping and supporting the base end portion of each of the first and second arms and said spacer between the fastening member and the flange.

19. The disk apparatus according to claim 16, wherein a portion of the first arm is fastened to said spacer by a screw.
